(19) United States
(12) Patent Application Publication
(10) Pub. No.: US 2008/0060538 A1
(43) Pub. Date: Mar. 13, 2008

(54) Method for automatically controlling the cut-off register in a web-fed rotary press

(75) Inventor: Klaus Theilacker, Friedberg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/891,782

(22) Filed: Aug. 13, 2007

(30) Foreign Application Priority Data
Aug. 12, 2006 (DE) 10 2006 037 946.2

(51) Int. Cl. B41F 13/56

(52) U.S. Cl. 101/226

(57) ABSTRACT

A method for automatically controlling the cut-off register in a web-fed rotary press includes determining an expected cut-off error in the area of harps for one of webs or partial webs before the formation of strands and automatically controlling the cut-off register of the one of the webs or partial webs by rotating plate cylinders involved in the printing of the respective web or partial web on the basis of the expected cut-off error thus determined for each web or partial web. The method further includes determining an expected cut-off error in the area of the folder upper section for at least some strands before a complete strand is formed, and automatically controlling the cut-off register by displacement of register rollers located downstream of the former in which the at least some strands are quarter-folded on the basis of the expected cut-off error thus determined for the at least some strands.

### BACKGROUND OF THE INVENTION

1. Field of the Invention

The invention relates to a method for automatically controlling the cut-off register in a web-fed rotary press such as, for example, a newspaper printing press.

2. Description of the Related Art

In web-fed printing presses, such as newspaper printing presses, several webs of printing material are printed in printing units arranged in printing towers. After the webs of printing material have been printed, these webs are usually cut into several partial webs by slitters. The partial webs thus produced by the slitting of the printed webs are then laid on top of each other in the area of the so-called harps to form several strands. Naturally, it is also possible for uncut printed webs to be laid on top of each other in the area of the harps to form several strands. The strands are quarter-folded in formers located downstream of the harps, and these quarter-folded strands are then combined into a complete strand in the area of an upper section of a folder. Copies are cut from the complete strand in the area of a jaw cassette, which is located downstream of the folder upper section, by cross-cutting in the area of a cutting cylinder, and the copies cut from the complete strand by cross-cutting are then cross-folded in the jaw cassette.

As has already been mentioned, copies are separated from the complete strand by cross-cutting in the area of the cutting cylinder of the jaw cassette. It is important here for the edges of the copies produced by cross-cutting to be a well-defined distance from the printed images. This well-defined distance of the edge of the copy produced by cross-cutting from the printed image is known as the cut-off register.

U.S. Pat. No. 7,162,954 describes a method for automatically controlling the cut-off register in a web-fed rotary press, in which individual measured values for the cutting points of individual webs are determined by web strand sensors before the individual webs are brought together to form one strand, and in which a measured value for the cutting point of the webs in the strand is determined by a bound strand sensor. These measured values are evaluated in a common control system to determine and automatically control the cutting points of the webs. A nested automatic control system of this type for the cut-off register is complicated.

### SUMMARY OF THE INVENTION

An object of the present invention is to provide a method for automatically controlling the cut-off register in a web-fed rotary press.

The object is met by a method for automatically controlling the cut-off register in a web-fed rotary press, especially a newspaper printing press, in which several webs of printing material are printed in printing units in the web-fed rotary press, and, after the webs of printing material have been printed, either several uncut webs or several partial webs that have been produced by the slitting of the printed webs are laid on top of one another in the area of harps to form several strands. The strands are quarter-folded in the area of formers arranged downstream of the harps, the quarter-folded strands are combined into a complete strand in the area of a folder upper section, and copies are cut from the complete strand by cross-cutting on a cutting cylinder of a jaw cassette and are then at least cross-folded in the jaw cassette.

According to the inventive method: (a) an expected cut-off error is determined in the area of the harps by sensors for each web or partial web before the strand in question is formed, and the cut-off register is automatically controlled by rotation of the plate cylinders involved in the printing of the web or partial web in question on the basis of the expected cut-off error thus determined for each web or partial web; and (b) independently of this automatic control of the cut-off register for each web or partial web, an expected cut-off error is determined in the area of the folder upper section for at least some of the strands before the complete strand is formed, and, on the basis of the expected cut-off error thus determined for these strands, the cut-off register is automatically controlled by displacement of register rollers located downstream of the former in which the given strand is quarter-folded.

In accordance with one embodiment of the present invention, the cut-off register is automatically controlled in web-fed rotary presses by correcting the expected cut-off error for each web or partial web, independently of the expected strand cut-off errors. This makes it possible to realize a simple automatic control structure for automatically controlling the cut-off error in a web-fed rotary press.

Preferably, the expected cut-off error is determined exclusively for those strands which are quarter-folded in balloon formers located above main formers and possibly in triple formers.

In accordance with another embodiment of the present invention, an expected cut-off error is determined in the area of the cutting cylinder of the jaw cassette for the complete strand independently of the automatic control of the cut-off register for each web or partial web and independently of the automatic control of the cut-off register for at least some of the strands, where, on the basis of the expected cut-off error thus determined for the complete strand, the cut-off register is automatically controlled by displacement of the register rollers over which the strands of the complete strand are guided.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred modifications of the invention are specified in the dependent claims and in the following description. A specific embodiment of the invention is explained in detail with reference to the embodiment, but it is understood that the invention is by no means limited to this embodiment. In the drawings:

FIG. 1 is a schematic sectional view of a web-fed rotary press to illustrate the method of the invention;

FIG. 2 is a side view of the web-fed rotary press in the direction 11 in FIG. 1 for further illustration of the method of the invention; and

FIG. 3 is a schematic block diagram showing the control loops for the method according to the present invention.

### DETAILED DESCRIPTION OF THE PRESENTLY PREFERRED EMBODIMENTS

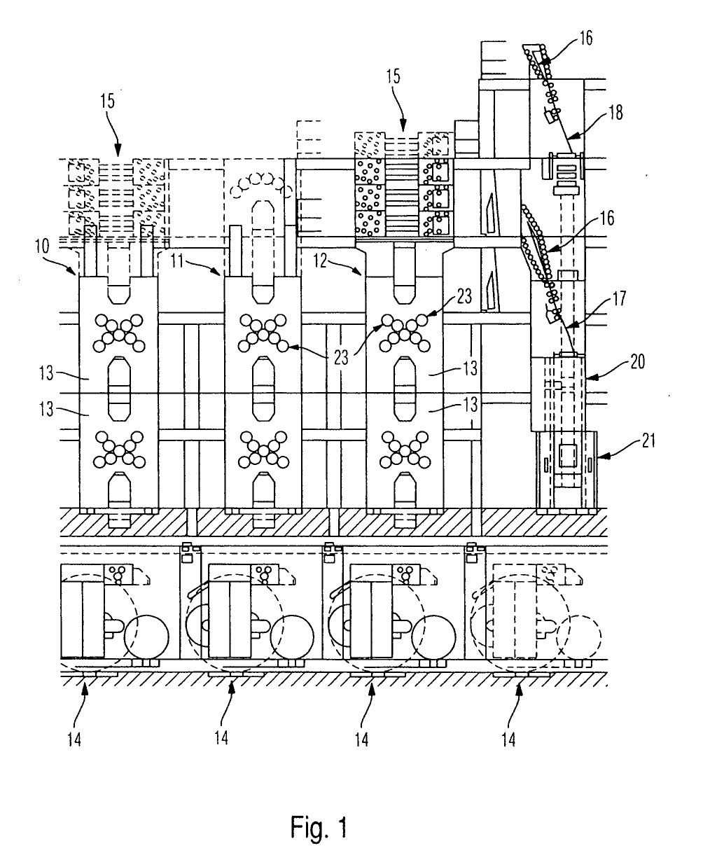

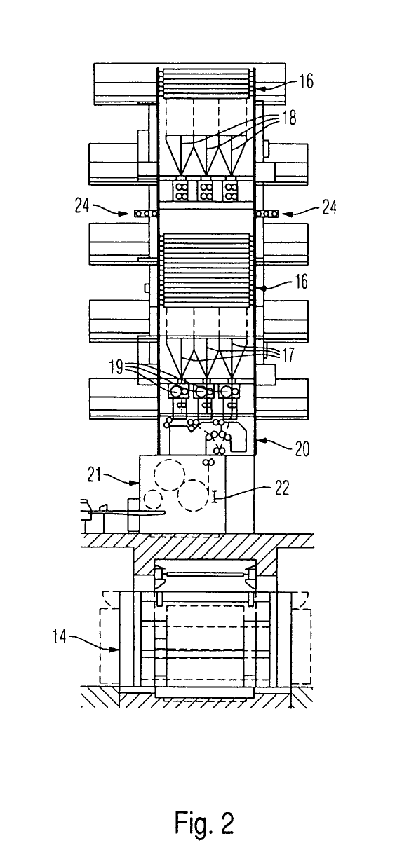

FIGS. 1 and 2 show a section of a web-fed rotary press, which is designed as a newspaper printing press. Three printing towers 10, 11, and 12 are shown in FIG. 1, each of which comprises two printing units 13 arranged one above the other. In the embodiment shown in FIGS. 1 and 2, each of the printing units 13 is designed as a nine-cylinder satellite unit. However, the printing units may comprise any other web fed rotary printing units known or hereafter developed.

Webs of printing material are fed into the printing towers 10, 11, and 12 from reel splicers 14 and are printed in the printing units 13 of the printing towers 10, 11, and 12. After being printed, webs of printing material printed in the printing units 13 of the printing towers 10, 11, and 12 are preferably cut into partial webs in turner assemblies 15 by slitting.

In the illustrated embodiment, after the printed webs have been cut into partial webs, the partial webs are fed into harps 16, and the partial webs are laid on top of each other in the area of the harps 16 to form strands, wherein each strand includes a plurality of the partial webs. In the illustrated embodiment, two harps 16 are positioned one above the other, and each partial web is fed into one of these two harps 16. If the webs are not cut into partial webs, then the webs themselves are laid on top of each other in the area of the harps 16 to form the strands.

In the illustrated embodiment of FIGS. 1 and 2, two former sets 17, 18 of three formers each are arranged downstream of each harp 16, and the strands formed in the area of the harps 16 are quarter-folded in one of the former sets 17, 18. The former in the lowermost former set 17 are known as main formers, and the formers in the former set 18 positioned above the main formers are known as balloon formers. Another unit consisting of an additional harp and an additional set of formers downstream of it can optionally be provided above the balloon formers 18 and the associated harp 16. The additional set of formers are also known as triple formers.

Stitchers 19 are arranged downstream of the main formers 17, so that strands that have been quarter-folded in the area of the main formers 17 can be stitched together.

Below the main formers 17, the quarter-folded strands are combined into a complete strand in the area of a folder upper section 20, and the complete strand formed in the folder upper section 20 is fed into a jaw cassette 21. In the area of a cutting cylinder 22 of the jaw cassette 21, copies are cut from the complete strand by cross-cutting, and these separated copies are then cross-folded in the jaw cassette 21.

The invention relates to a method for automatically controlling the cut-off register in a web-fed rotary press. The cut-off register determines the distance between the edge produced by cross-cutting a copy from the complete strand in the area of the cutting cylinder 22 and the printed image on the copy.

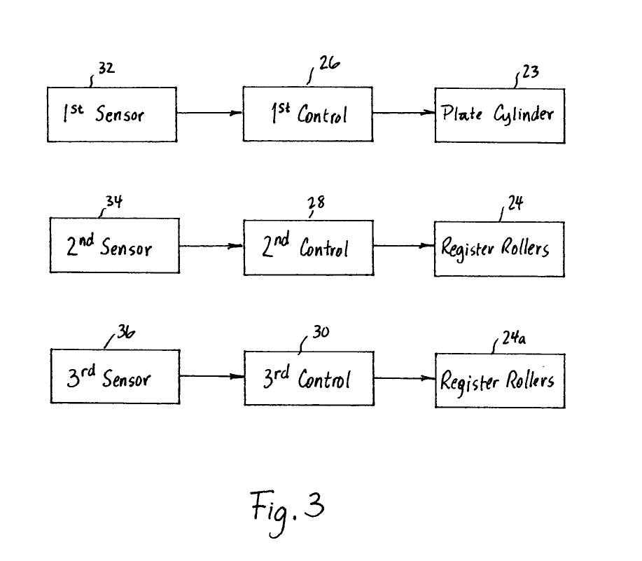

FIG. 3 shows control loops for effecting the inventive method. In accordance with the method of the present invention, to realize automatic control of the cut-off register, an expected cut-off error is measured in the area of the harps 16 by a first sensor 32 for each web or partial web before the strand in question is formed. The cut-off register for each web or partial web is controlled automatically by a first control 26 on the basis of the expected cut-off error thus determined for the partial webs by rotating the plate cylinders 23 of the printing units 13 that are involved in the printing of the respective partial web. The measured values of the expected cut-off errors for each partial web, which are determined in the area of the harps 16, are thus used, in accordance with the present invention, exclusively for rotating the corresponding plate cylinders 23.

Before the complete strand is formed, an expected cut-off error is measured by a second sensor 34 according to the present invention in the area of the folder upper section 20 for at least some of the strands produced in the area of the harps 16 independently of the above automatic cut-off register control for the partial webs.

The cut-off register is automatically controlled by a second control 28 on the basis of the expected cut-off error thus determined for these strands, specifically, by displacement of register rollers 24 located downstream of the former in which the given strand is quarter-folded. The expected cut-off errors for the strands determined in the area of the folder upper section 20 before formation of the complete strand are thus used exclusively for the displacement of the register rollers 24.

In the illustrated embodiment, register rollers 24 are arranged downstream only of the balloon formers 18, since the distance of the main formers 17 from the folder upper section 20 is sufficiently small that it can be assumed that, due to the small distance between the main formers 17 and the folder upper section 20, the strands quarter-folded in the main formers 17 undergo hardly any deviation in the cut-off register during transport to the folder upper section 20. If triple formers are present, the register rollers in question will be installed downstream of them.

In the specific embodiment illustrated in FIGS. 1 and 2, the expected cut-off error is thus determined exclusively for those strands which are quarter-folded in balloon formers 18 arranged above the main formers 17 and possibly in the triple formers arranged above the balloon formers.

In accordance with the above description of the present invention, the automatic control of the cut-off register is based on two closed-loop control systems that operate independently of each other. The first closed-loop control system controls the plate cylinders 23 of the printing units 13 on the basis of expected cut-off errors measured in the area of the harps 16 for each partial web, and the second closed-loop control system, independently of the first system, controls register rollers 24 on the basis of expected cut-off errors determined for strands in the area of the folder upper section 20.

In accordance with a further embodiment of the present invention, a third closed-loop control system is present, which operates independently of the two closed-loop control systems mentioned above and determines an expected cut-off error in the area of the cutting cylinder 22 of the jaw cassette 21 for the complete strand using a third sensor 36. On the basis of the expected cut-off error thus determined for the complete strand, a third control 30 of the third closed-loop control system preferably controls register rollers 24a over which the strands of the complete strand are guided.

It should be noted that the register rollers 24a are provided downstream of the main formers 17. These register rollers 24a can be controlled on the basis of the expected cut-off error determined for the strands in the area of the folder upper section 20 or on the basis of the expected cut-off error for the complete strand in the area of the cutting cylinder 22.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for automatically controlling the cut-off register in a web-fed rotary press, in which webs of printing material are printed in printing units in the web-fed rotary press, strands are formed by laying the printed webs or partial webs produced by slitting the printed webs on top of one another in harps, the strands are quarter-folded in formers arranged downstream of the harps, the quarter-folded strands are combined into a complete strand in a folder upper section, copies are cut from the complete strand by cross-cutting on a cutting cylinder of a jaw cassette, and the copies are cross-folded in the jaw cassette, the method comprising the steps of:
(a) determining an expected cut-off error in the area of the harps for one of the printed webs or partial webs before the formation of a respective one of the strands and automatically controlling the cut-off register of the one of the webs or partial webs by rotating plate cylinders involved in the printing of the respective web or partial web on the basis of the expected cut-off error thus determined for each web or partial web; and
(b) independently of step (a), determining an expected cut-off error in the area of the folder upper section for at least some of the strands before the complete strand is formed, and automatically controlling the cut-off register by displacement of register rollers located downstream of the former in which the at least some of the strands are quarter-folded on the basis of the expected cut-off error thus determined for the at least some of the strands.

2. The method of claim 1, wherein step (b) is performed exclusively for a subset of the strands that are quarter-folded in balloon formers located upstream of main formers and possibly in triple formers.

3. The method of claim 1, further comprising the step of, independently of steps (a) and (b), determining an expected cut-off error for the complete strand in the area of the cutting cylinder of the jaw cassette, and automatically controlling the cut-off register by displacement of further register rollers over which the complete strand is guided on the basis of the expected cut-off error thus determined for the complete strand.

4. The method of claim 1, wherein the web-fed rotary press is a newspaper printing press.
